(19) United States
(12) Patent Application Publication
(10) Pub. No.: US 2002/0084993 A1
(43) Pub. Date: Jul. 4, 2002

(54) ORGANIC EL EMISSION DEVICE AND METHOD OF DRIVING THE SAME

(76) Inventors: MOTOTAKA TANEYA, NARA-SHI (JP); TOSHIKI HIJIKATA, SHIKI-GUN (JP); KAZUHIRO EMOTO, NAGAOKAKYO-SHI (JP)

Correspondence Address: NIXON & VANDERHYE PC, 1100 NORTH GLEBE ROAD 8TH FLR, ARLINGTON, VA, 222014714

(21) Appl. No.: 09/369,386

(22) Filed: Aug. 6, 1999

(30) Foreign Application Priority Data
Sep. 2, 1998 (DE) 10-248292

(51) Int. Cl. G09G 5/00

(52) U.S. Cl. 345/204

(57) ABSTRACT

The organic EL emission device includes an organic light emission layer for EL emission sandwiched between first and second electrode layers, at least one of which is transparent. At least the first electrode layer includes a plurality of electrodes arranged with spatial periodicity. The plurality of electrodes included in the first electrode layer together with adjacent regions in the second electrode layer including one or more electrodes form a plurality of electrode pair regions arranged with spatial periodicity. The method of driving the organic EL emission device is characterized in that electric fields having either different strengths or directions are applied with variation in a time-dependent manner to electrode pair regions adjacent to each other among the plurality of electrode pair regions.

### BACKGROUND OF THE INVENTION

1. Field of the Invention

The present invention relates to a technique of realizing a high luminance, long life light emission of an organic electroluminescence (EL) emission device including an organic compound which is an EL substance that emits light by injection of current.

2. Description of the Background Art

In recent years, as progress is being made in the field of portable informational equipments and as screens of information display devices have increasingly been enlarged, it is desired to realize lightweight, thin-type planar light emission devices having a low power consumption characteristic, particularly display devices utilizing EL emission for practical use.

The EL emission devices can be classified into the following two groups according to material of a light emission layer sandwiched between two electrode layers included in the EL emission device: inorganic EL emission devices and organic EL emission devices. In general, the inorganic EL emission device utilizes fluorescence emitted by relaxation of energy at luminescence centers. The luminescence center is excited by collision with accelerated electrons that reside inside the light emission layer with a high electric field between the two electrode layers. Thus, in the inorganic EL emission device, application of a high voltage is required.

On the other hand, an organic EL emission device utilizes fluorescence emitted when organic molecules return to their ground state of energy from their excited state caused by recombination of holes and electrons at luminescence centers. The holes and electrons are injected into the light emission layer from a positive electrode layer and a negative electrode layer, respectively. Thus, in general, the organic EL emission device is characterized in that direct current (DC) is injected into the light emission layer to produce EL emission. Moreover, since the organic EL emission device can be driven at a low voltage of approximately 15 V or below unlike the inorganic EL emission device requiring an applied voltage of 100 V or above, the use of the former is expected in a wide range of equipment applications. The organic EL emission device hopeful for high luminance light emission and low power consumption can be utilized for various display devices in informational equipments, light sources for illumination replacing fluorescent lamps, backlights for various display devices, and light sources for printers. Thus, the potential demand for the organic EL emission device is immeasurable.

There are three kinds of basic structures applicable to a structure between the two electrode layers in an organic EL emission device. The first kind is a two-layer structure in which an electron transporting layer is stacked on an organic compound layer having both characteristics of a hole transporting layer and a light emission layer. The second kind is a two-layer structure in which a hole transporting layer is stacked on an organic compound layer having both characteristics of an electron transporting layer and a light emission layer. The third kind is a double-hetero structure in which a light emission layer of an organic compound is sandwiched between a hole transporting layer and an electron transporting layer. The third kind is used particularly when the light emission intensity and the color of the emitted light need to be controlled.

In making these structures possible, various organic compound materials have been developed which can serve the functions of the respective layers between the electrodes. For instance, aluminum trisoxine, stilamine derivatives, stilbenzene derivatives, and aminopyrene derivatives are usable as the material for the light emission layer. Phthalocyanines, aromatic tertiary-amines, and the like are usable for the hole transporting layer. Oxadiazol derivatives and the like can be used for the electron transporting layer.

For the two electrode layers, a material having a large work function is used for the positive electrode layer for effective injection of holes into the light emission layer or the hole transporting layer, while a material having a small work function is used for the negative electrode layer for effective injection of electrons into the light emission layer or the electron transporting layer.

The organic EL emission device as described above is generally driven by DC power and in general has a short lifetime. That is, it is not easy to obtain an organic EL emission device capable of maintaining light emission at a high luminance level over a long period of time. Deterioration of the organic EL emission device which continuously emits light by application of forward DC voltage is possibly caused by charge accumulation in the interface of the electrode layer and the carrier transporting layer or in the interface of the carrier transporting layer and the light emission layer, or by lowered carrier injection efficiency as a result of defects induced by dielectric polarization of organic molecules under a constant electric field. In addition, such charge accumulation and defects that occur unevenly from place to place may lead to localized concentration of the applied voltage or current, to a fixed charge transporting path in the carrier transporting layer or the light emission layer, and thus to accelerated deterioration of the organic EL emission device.

In the attempt to reduce such deterioration in the organic EL emission device, one report (Japanese Patent Laying-Open No. 4-308687) describes intermittent application of reverse voltage to two opposing electrode layers, which led to a successful suppression of the deterioration over time. Another report (Japanese Patent Laying-Open No. 4-349388) describes a success in maintaining luminance over a long period of time by application of an alternating voltage whose polarity alternately changes between the electrode layers. There is, however, no report that the standard time level of luminance considered to be sufficient for practical use, i.e. luminance maintained for 5000 hours (luminance retention of 0.7), has been achieved. At present, the cause of luminance deterioration itself is not yet fully revealed.

### SUMMARY OF THE INVENTION

In view of the problems found in the prior art examples, one object of the present invention is to provide a technique which enables an organic EL emission device to emit light at a high luminance level over a long lifetime.

In the present invention, the organic EL emission device includes first and second electrode layers, at least one of which is transparent, and an organic light emission layer for EL emission sandwiched between the first and second electrode layers, wherein at least the first electrode layer includes a plurality of electrodes arranged with spatial periodicity, and the plurality of electrodes included in the first electrode layer together with adjacent regions in the second electrode layer including one or more electrodes form a plurality of electrode pair regions arranged with spatial periodicity. Electric fields having at least either different strengths or directions are applied by a voltage application device with variation in a time-dependent manner to electrode pair regions adjacent to each other among the plurality of electrode pair regions.

Thus, according to the present invention, an electrode pair region where at least no strong injection of carriers occurs is provided adjacent to an electrode pair region where holes and electrons are injected into the light emission layer by the application of a forward voltage, and the voltages applied to the adjoining electrode pair regions are varied in a time-dependent manner.

Since a light emitting region to which a forward voltage is applied is limited in time and space, electric field in the light emitting region is more uniformly applied than in conventional case of the intermittent reverse voltage application where the light emitting layer as a whole is made intermittently to emit light or to cease light emission. Further, the polarizing orientation of organic molecules and the accumulation of charges which is likely to occur in the vicinity of the layer interface in an electrode pair region to which a forward voltage is applied tend to be prevented by the application of a reverse voltage or a voltage of a different magnitude to the adjacent electrode pair. Furthermore, by alternately and in a time-dependent manner reversing the polarities of the voltages applied between the electrode pairs adjacent to one another, the factors inducing deterioration of the organic EL emission device can be eliminated more speedily.

The present invention has a disadvantage of initial luminance being reduced by half owing to the fact that, given that the area of each electrode pair is the same, the area of the light emitting region at any given point in time is reduced to a half of the total area of the light emission layer when a forward voltage and a reverse voltage are respectively applied in a time-dependent manner to at least two electrode pair regions provided adjacent to one another. The advantages of the present invention, namely, long lifetime and stable luminance level made possible by preventing deterioration of the organic EL emission device, however, more than make up for such a minor disadvantage.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross sectional view showing an organic EL emission device according to a first embodiment of the present invention.

FIG. 2 is a schematic block diagram showing an organic EL emission device according to a second embodiment of the present invention.

FIG. 3 is a timing chart illustrating an example of voltages applied to drive the organic EL emission device of FIG. 2.

FIG. 4 is a schematic cross sectional view showing an organic EL emission device according to a third embodiment of the present invention.

### DESCRIPTION OF THE PREFERRED EMBODIMENTS

### First Embodiment

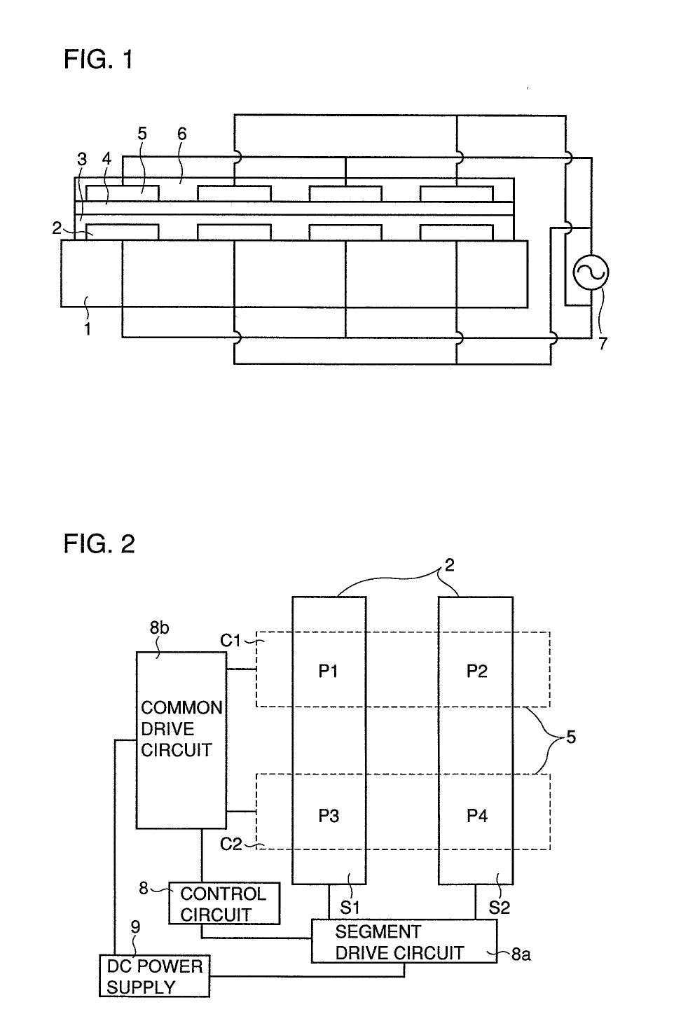

In FIG. 1, an organic EL emission device according to a first embodiment of the present invention is illustrated in a schematic cross sectional view. In forming an organic EL emission panel shown in FIG. 1, a plurality of stripe-like transparent electrodes 2 made of ITO (indium tin oxide) are formed on a glass substrate 1, and then, ultrasonic cleaning in isopropyl alcohol is carried out followed by ten minutes of ultraviolet cleaning. These stripe-like transparent electrodes 2 extend in a direction orthogonal to the sheet of FIG. 1, each having a width of 50 μm and a length of 17 mm, and arranged at a pitch of 100 μm. Besides ITO, other transparent conductive oxides having a work function of preferably 4 eV or greater may be used as the material for transparent electrode 2 serving as a hole injecting electrode.

On transparent electrode 2, a bis-enamine compound [N,N′-diphenyl-N,N′-di(1,2,3,4-tetrahydronaphthyl-1-methylidinyl) benzidine] layer is deposited as a hole transporting layer 3 to a thickness of 200 nm by vacuum evaporation, and thereafter, BeBq2 [bis(10-hydroxybenzo[h]quinonate) beryllium] layer is deposited to a thickness of 200 nm similarly by vacuum evaporation as a light emission layer 4 having an electron-donating function.

A plurality of stripe-like electron injecting electrodes 5 are formed on light emission layer 4 by depositing a 200 nm thick MgIn co-deposited layer by electron beam deposition using a masking method. Various metal materials such as Mg, Sn, In, and the like having work functions of preferably less than 4 eV may be used as the material for electron injecting electrode 5. In the embodiment shown in FIG. 1, electron injecting electrode 5 has the same width and length as transparent electrode 2, and is positioned opposite to transparent electrode 2.

The top surface of the organic EL emission panel is coated with a 40 nm thick silicon nitride film 6 except for the portions for wire connection to electrodes 2 and 5 in order to protect organic compound layers 3 and 4 from moisture and oxygen in the atmosphere.

In the organic EL emission panel thus formed, among the plurality of hole injecting electrodes 2 a plurality of odd-numbered electrodes are electrically connected with one another, and a plurality of even-numbered electrodes are also electrically connected with one another. Similarly, among the plurality of electron injecting electrodes 5 a plurality of odd-numbered electrodes are electrically connected with one another, and a plurality of even-numbered electrodes are also electrically connected with one another. In addition, among a plurality of electrode pairs each made of hole injecting electrode 2 and electron injecting electrode 5 opposing one another, the odd-numbered electrode pair and the even-numbered electrode pair are connected to alternating voltage source 7 so that the voltages applied to the odd-numbered electrode pair and the even-numbered electrode pair can be opposite in polarity.

With such electrical connections, application of a sine-wave voltage of 60 Hz at an effective voltage of 15 V to electrode pair 2, 5 from alternating voltage source 7 produces bluish green light having a luminance of 3400 Cd/m². After 1000 hours of operation, a luminance retention of 0.96 with respect to the initial emission luminance is obtained, and it has been confirmed that this luminance retention achieved is of a sufficient level for practical use. In this case, voltages applied from alternating voltage source 7 to one electrode pair 2, 5 and another electrode pair adjacent to electrode pair 2, 5 are opposite in polarity so that the polarization tendency of organic molecules and the accumulation of charges in the vicinity of the interface of organic compound layers in the electrode pair region are expected to be mitigated.

Although the two-layer structure of hole transporting layer 3 and organic light emission layer 4 is employed in the embodiment of FIG. 1, a three-layer structure having an additional electron transporting layer sandwiched between organic light emission layer 4 and electron injecting electrode 5 may be employed. A stacked two-layer structure of an organic light emission layer serving a hole transporting function and an electron transporting layer may also be employed. Further, hole injecting electrode 2 and electron injecting electrode 5 need not be positioned in mirror symmetry, and one electrode can be shifted with respect to the other electrode by less than half a pitch. In addition, a plurality of dot-like electrodes may be provided in place of the plurality of stripe-like electrodes. Furthermore, the time periodicity of the applied alternating voltage need not be constant, and if desired, voltage of various waveforms such as rectangular waves and sawteeth waves may be used instead of sine waves.

### Second Embodiment

In a second embodiment, an organic EL emission panel similar to the one shown in FIG. 1 is produced from steps similar to those of the first embodiment. The organic EL emission panel according to the second embodiment is different from the panel shown in FIG. 1 only in that the dimensions and arrangement of hole injecting electrode 2 and electron injecting electrode 5 have been altered, as illustrated schematically in the block diagram of FIG. 2.

More specifically, in the second embodiment, each of two strips of hole injecting electrodes 2 and each of two strips of electron injecting electrodes 5 have a width of 10 μm and a length of 22 mm, and are positioned at a pitch of 10.1 μm. Here, however, hole injecting electrode 2 and electron injecting electrode 5 are positioned such that they intersect at right angles. It is understood that hole injecting electrode 2 and electron injecting electrode 5 need not intersect at right angles, and may intersect at any angle other than right angles, if so desired.

As shown in FIG. 2, the two strips of hole injecting electrodes 2 are connected to a segment drive circuit 8a as segment electrodes S1 and S2, while the two strips of electron injecting electrodes 5 are connected to a common drive circuit 8b as common electrodes C1 and C2. Segment drive circuit 8a and common drive circuit 8b are controlled by a control circuit 8, and are provided with DC voltage from DC power supply 9.

A region where segment electrode S1 and common electrode C1 intersect forms an electrode pair region P1. Similarly, a region where segment electrode S2 and common electrode C1 intersect forms an electrode pair region P2, a region where segment electrode S1 and common electrode C2 intersect forms an electrode pair region P3, and a region where segment electrode S2 and common electrode C2 intersect forms an electrode pair region P4.

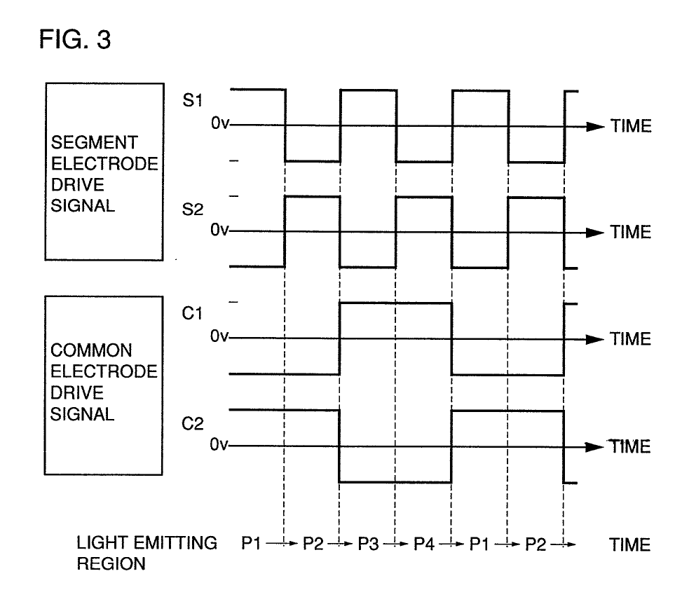

FIG. 3 represents relation between a timing chart of voltage application and light emitting electrode pair regions according to a method of driving the organic EL emission device of FIG. 2. According to this driving method, voltages of 6 V and −6 V (forward voltages) are first respectively applied to segment electrode S1 serving as a hole injecting electrode and to common electrode C1 serving as an electron injecting electrode, and voltages having the polarity reversed are applied to other electrodes S2 and C2, respectively. Consequently, electrode pair region P1 emits light, while other electrode pair regions P2, P3, and P4 do not emit light, and charge residing in the layer interface is advantageously removed. Then, in order to allow electrode pair region P2 alone to emit light, voltages for segment electrodes S1 and S2 are reversed in polarity in synchronism, while voltages for other electrodes C1 and C2 are maintained. Next, in order to allow electrode pair region P3 alone to emit light, voltages for all electrodes S1, S2, C1, and C2 are reversed in polarity at the same time. Further, in order to allow electrode pair region P4 alone to emit light, voltages for electrodes S1 and S2 are reversed in polarity in synchronism, while voltages for other electrodes C1 and C2 are maintained.

Thus, when four electrode pair regions P1-P4 are made to emit light one after another in sequence each 5 msec in the above-described manner, bluish green light having a luminance of 1250 Cd/m² is emitted, and a luminance retention of 0.97 with respect to the initial emission luminance is obtained after 5000 hours of operation.

Although the organic EL emission panel having only four electrode pair regions P1-P4 is shown in FIG. 2 for simplicity of description, it is understood without saying that the panel may include a larger number of electrode pair regions. Even in such a case, it is possible selectively to allow one electrode pair region to emit light at a time, or to allow a half or a fourth of the total number of electrode pair regions to emit light at a time. In addition, a segment electrode drive signal and a common electrode drive signal can be appropriately controlled to produce a light emitting image.

### Third Embodiment

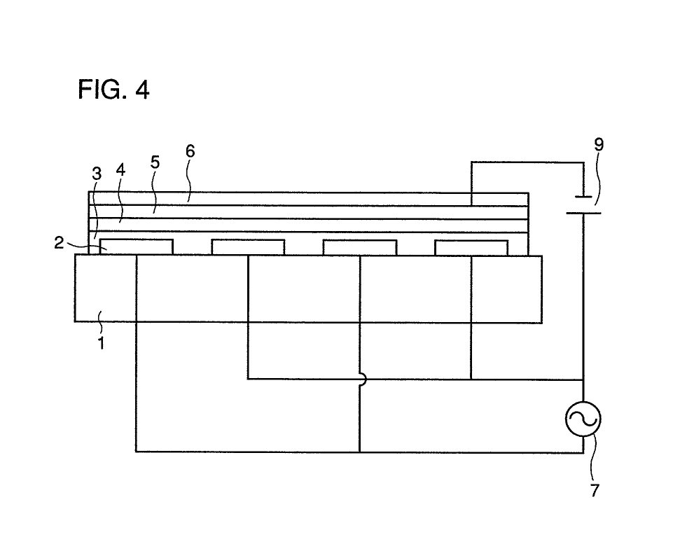

In a third embodiment, also, an organic EL emission panel similar to the one shown in FIG. 1 is produced from steps similar to those of the first embodiment. The organic EL emission panel according to the third embodiment differs from the panel shown in FIG. 1 only in that electron injecting electrode 5 is formed as a sheet of a common electrode, as illustrated schematically in a cross sectional view of FIG. 4.

As shown in FIG. 4, a forward voltage of 5 V is applied between a plurality of hole injecting electrodes 2 and a sheet of electron injecting common electrode 5 from DC voltage power supply 9. At the same time, a sine-wave voltage of 60 Hz at an effective voltage of 6 V is applied between odd-numbered hole injecting electrodes 2 and even-numbered hole injecting electrodes 2 from alternating current power supply 7.

In the third embodiment, bluish green light having a luminance of 3380 Cd/m² is emitted, and a luminance retention of 0.94 with respect to the initial emission luminance is obtained after 5000 hours of operation.

As seen from the above, according to the present invention, the light emitting area on the organic EL emission panel is divided into a plurality of electrode pair regions, and electric fields having at least either different strengths or directions are applied with variation in a time-dependent manner to electrode pair regions adjacent to each other among the plurality of electrode pair regions, which leads to prevention of deterioration of light emission panel owing to charge accumulation in the vicinity of the light emission layer interface. Thus, it becomes possible to drive the organic EL emission device at a high luminance level over a long lifetime.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. In an organic EL emission device including
first and second electrode layers, at least one of which is transparent, and
an organic light emission layer for EL emission sandwiched between said first and second electrode layers, wherein
at least said first electrode layer includes a plurality of electrodes arranged with spatial periodicity, and
said plurality of electrodes included in said first electrode layer together with adjacent regions in said second electrode layer including at least one electrode form a plurality of electrode pair regions arranged with spatial periodicity,
a method of driving said organic EL emission device, wherein
electric fields with at least either different strengths or directions are applied with variation in a time-dependent manner to electrode pair regions adjacent to each other among said plurality of electrode pair regions.

2. The method of driving the organic EL emission device according to claim 1, wherein electric fields with at least either different strengths or directions to be applied to electrode pair regions adjacent to each other among said plurality of electrode pair regions are varied with a constant time periodicity.

3. The method of driving the organic EL emission device according to claim 2, wherein alternating voltages with opposite polarities are applied to electrode pair regions adjacent to each other among said plurality of electrode pair regions.

4. The method of driving said organic EL emission device according to claim 1, wherein at least said first electrode layer includes a plurality of electrodes in one of a dot-like form and a stripe-like form.

5. The method of driving the organic EL emission device according to claim 4, wherein said second electrode layer includes a plurality of stripe-like electrodes positioned in parallel to the plurality of stripe-like electrodes included in said first electrode layer.

6. The method of driving the organic EL emission device according to claim 4, wherein said second electrode layer includes a plurality of stripe-like electrodes arranged to intersect the plurality of stripe-like electrodes included in said first electrode layer.

7. The method of driving the organic EL emission device according to claim 1, wherein a first group of electrodes including every other electrode are electrically connected to each other, and a second group of electrodes that remain besides said first group of electrodes are electrically connected to each other in said first electrode layer.

8. The method of driving the organic EL emission device according to claim 5, wherein a first group of electrodes including every other electrode are electrically connected to each other, and a second group of electrodes that remain besides said first group of electrodes are electrically connected to each other in said second electrode layer.

9. The method of driving the organic EL emission device according to claim 6, wherein a first group of electrodes including every other electrode are electrically connected to each other, and a second group of electrodes that remain besides said first group of electrodes are electrically connected to each other in said second electrode layer.

10. An organic EL emission device, comprising:
first and second electrode layers, at least one of which is transparent;
an organic light emission layer for EL emission sandwiched between said first and second electrode layers; and
voltage application means for applying a voltage between an electrode included in said first electrode layer and an electrode included in said second electrode layer, wherein
at least said first electrode layer includes a plurality of electrodes arranged with spatial periodicity,
said plurality of electrodes included in said first electrode layer together with adjacent regions in said second electrode layer including at least one electrode form a plurality of electrode pair regions arranged with spatial periodicity, and
said voltage application means applies electric fields with at least either different strengths or directions to electrode pair regions adjacent to each other among said plurality of electrode pair regions with variation in a time-dependent manner.
